(19) United States
(12) Patent Application Publication
(10) Pub. No.: US 2005/0253514 A1
(43) Pub. Date: Nov. 17, 2005

(54) Plasma display panel

(76) Inventors: Byoung-Min Chun, Suwon-si (KR); Jeong-Nam Kim, Suwon-si (KR); Jeong-Doo Yi, Suwon-si (KR); Tae-Woo Kim, Suwon-si (KR); Gab-Sick Kim, Suwon-si (KR); Joon-Yeon Kim, Suwon-si (KR)

Correspondence Address: MCGUIREWOODS, LLP, 1750 TYSONS BLVD, SUITE 1800, MCLEAN, VA, 22102, US

(21) Appl. No.: 11/121,069

(22) Filed: May 4, 2005

(30) Foreign Application Priority Data
May 14, 2004 (KR) 10-2004-0034219

(51) Int. Cl. H01J 17/49

(52) U.S. Cl. 313/582

(57) ABSTRACT

A plasma display panel includes a first substrate and a second substrate provided opposing one another with a gap therebetween, barrier ribs formed in the gap to define a plurality of discharge cells, address electrodes formed along a first direction and intersecting areas corresponding to the discharge cells, display electrodes formed on the first substrate along a second direction substantially perpendicular to the first direction, and an external light absorbing layer covering the display electrodes.

### CROSS REFERENCE TO RELATED APPLICATION

This application claims priority to and the benefit of Korean Patent Application No. 10-2004-0034219, filed on May 14, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP with improved contrast.

2. Description of the Background

A PDP displays images by exciting phosphors with a plasma discharge. That is, vacuum ultraviolet (VUV) rays emitted from plasma obtained via gas discharge excite phosphor layers, which then emit visible red (R), green (G), and blue (B) light to thereby form images. The PDP's many advantages include an ability to be made with a large screen size of 60 inches or more, a thin profile of 10 cm or less, a wide viewing angle and good color reproduction, and high productivity and low manufacturing costs due to simpler manufacturing processes than liquid crystal displays (LCDs). Consequently, the PDP is being increasingly used at home and in industry.

FIG. 5 shows a partial exploded perspective view of a conventional alternating current (AC) PDP. The conventional AC PDP may include a rear substrate 101 and a front substrate 111 facing one another with a gap therebetween. A plurality of stripe-shaped address electrodes may be formed on an upper surface of the rear substrate 101 substantially along a direction X. A first dielectric layer 105 covers the address electrodes 103, and a plurality of barrier ribs 107 may be formed on the first dielectric layer 105. The barrier ribs 107 may be formed in a stripe pattern along direction X and in between the address electrodes 103. Red, green, and blue phosphor layers 109R, 109G, 109B may be respectively formed between adjacent pairs of the barrier ribs 107. The phosphor layers 109R, 109G, 109B cover the first dielectric layer 105 between the barrier ribs 107, as well as side walls of the barrier ribs 107.

A plurality of display electrodes, i.e., a plurality of pairs of X, Y electrodes 113, 115 may be formed on a lower surface of the front substrate 111. The X electrodes 113 may include a transparent electrode 113a extending along direction Y and a bus electrode 113b formed thereon, and, similarly, the Y electrodes 115 may include a transparent electrode 115a extending along direction Y and a bus electrode 115b formed thereon. A second dielectric layer 117 and a protection layer 119 may be formed on the front substrate 111 to cover the X, Y electrodes 113, 115.

Each area between an intersection of an address electrode 103 and a pair of the X, Y electrodes 113, 115 forms a discharge cell 121R, 121G, or 121B. A few hundred million pixels may be formed in a matrix configuration by this arrangement.

With the above structure, applying an address voltage between an address electrode 103 and a Y electrode 115 generates an address discharge to select a discharge cell. Applying a sustain voltage between the Y electrode and the X electrode of the selected discharge cell generates a plasma discharge within the selected discharge cell, thereby emitting VUV rays, which excite the phosphors of the discharge cell to emit visible light, thereby displaying the desired images.

The visible light must pass through the front substrate 111 so that a viewer may see the generated images. However, the front substrate 111 may reflect external light, which lessens the contrast of the generated images.

### SUMMARY OF THE INVENTION

The present invention provides a PDP that may absorb external light directed onto a front substrate, thereby improving the PDP's contrast.

Additional features of the invention will be set forth in the description which follows, and in part will be apparent from the description, or may be learned by practice of the invention.

The present invention discloses a plasma display panel including a first substrate and a second substrate provided opposing one another with a gap therebetween, barrier ribs formed in the gap to define a plurality of discharge cells, address electrodes formed along a first direction and intersecting areas corresponding to the discharge cells, display electrodes formed on the first substrate along a second direction substantially perpendicular to the first direction, and an external light absorbing layer covering the display electrodes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic partial plan view showing a PDP according to a first exemplary embodiment of the present invention.

FIG. 2 is a sectional view taken along line A-A of FIG. 1.

FIG. 3 is a schematic partial plan view showing a PDP according to a second exemplary embodiment of the present invention.

FIG. 4 is a schematic partial plan view showing a PDP according to a third exemplary embodiment of the present invention.

FIG. 5 is a partial exploded perspective view of a conventional PDP.

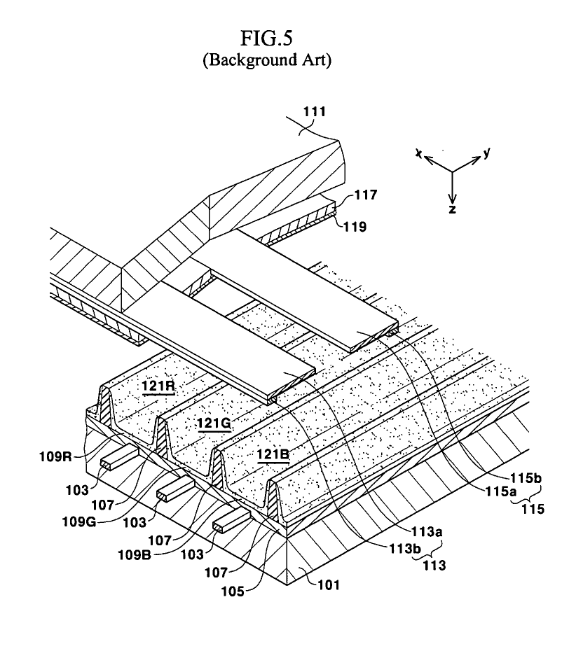

### DETAILED DESCRIPTION

Exemplary embodiments of the present invention will now be described with reference to the drawings.

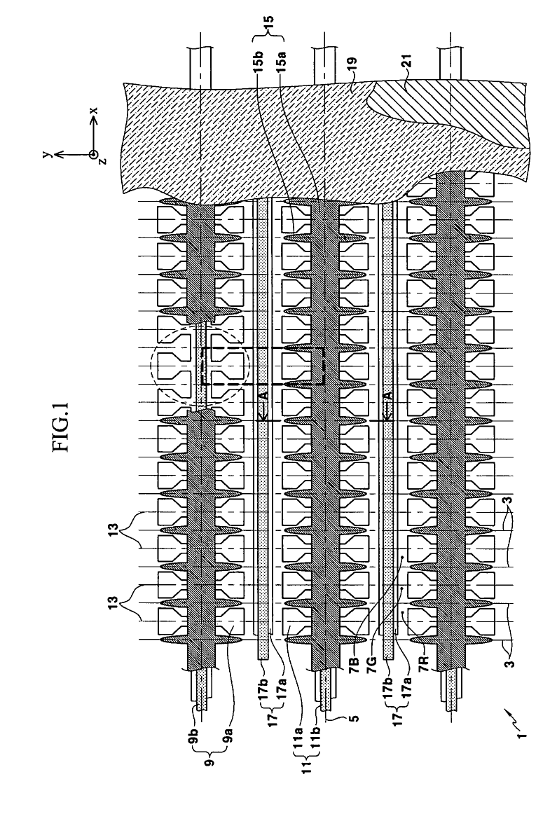

FIG. 1 is a schematic partial plan view of a PDP according to a first exemplary embodiment of the present invention.

Referring to FIG. 1, the PDP may include a first substrate 1 (hereinafter referred to as a front substrate) and a second substrate (not shown and hereinafter referred to as a rear substrate). The front substrate 1 and the rear substrate may be sealed together, and an inert gas may be filled in a gap between them. A plurality of barrier ribs 3, 5 may be arranged between the front substrate 1 and the rear substrate to define a plurality of discharge cells 7R, 7G, 7B, within which a plurality of red (R), green (G), and blue (B) phosphor layers are formed, respectively.

A plurality of address electrodes 13 (only locations are shown in FIG. 1) may be formed on the rear substrate and in a Y direction. A plurality of display electrodes 9, 11 may be formed on the front substrate 1 extended along a direction X, which is substantially perpendicular to the direction Y along which the address electrodes extend.

The address electrodes are typically formed on the rear substrate, as is the case in the exemplary embodiment of the present invention. However, other configurations include forming the address electrodes on the front substrate 1 or on the barrier ribs 3. The address electrodes may be covered with a first dielectric layer (not shown) to allow for the formation of wall charges in the discharge cells 7R, 7G, 7B.

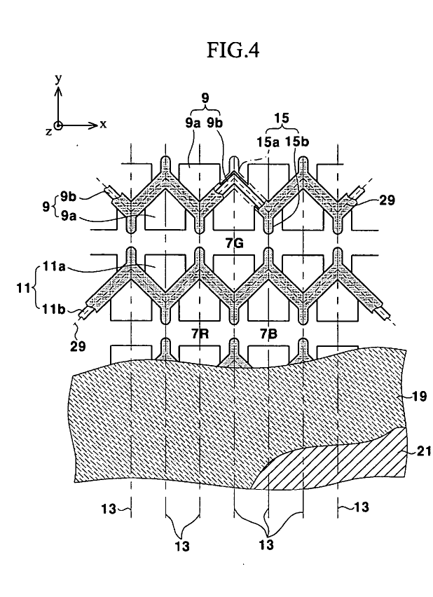

The barrier ribs 3, 5 may be formed in a matrix configuration in which the barrier ribs 3 are formed substantially along direction Y and the barrier ribs 5 are formed substantially along direction X and intersect the barrier ribs 3. Further, the barrier ribs 5 may be aligned with the display electrodes 9, 11. That is, this exemplary embodiment shows closed, or matrix type, discharge cells 7R, 7G, 7B defined by the barrier ribs 3 and the barrier ribs 5. However, the present invention is not limited to this configuration. The barrier ribs 5 may be omitted, and the barrier ribs 3 may be formed in a stripe pattern, thereby defining the discharge cells 7R, 7G, 7B between adjacent pairs of the barrier ribs 3. Alternatively, the barrier ribs 3, 5 may be formed so that the discharge cells 7R, 7G, 7B have other shapes, such as the hexagonal formation shown in FIG. 4, or other polygonal shapes.

An external light absorbing layer 15 may cover the display electrodes 9, 11. The external light absorbing layer 15 absorbs external light that is irradiated onto the PDP, thereby improving the PDP's contrast and its bright room contrast, in particular. The external light absorbing layer 15 may be formed in non-discharge regions of the front substrate 1 to prevent a reduction in brightness of the discharge cells 7R, 7G, 7B. Since the formation of the barrier ribs 3, 5 determines the locations of the non-discharge regions, in this exemplary embodiment, the external light absorbing layer 15 may be formed in a lattice-type of configuration corresponding to the closed barrier rib structure. If a striped barrier rib structure is used, a striped configuration may be used for the external light absorbing layer 15.

In this exemplary embodiment, therefore, each external light absorbing layer 15 includes a first section 15a, which extends along direction X and corresponds to a location of a barrier rib 5 to fully cover the same, and a plurality of second sections 15b, which extend a predetermined distance from the first section 15a along direction Y and at locations corresponding to the barrier ribs 3 to partially cover the same. Preferably, a pair of the second sections 15b extends from opposite sides of the first section 15a at each location where the barrier ribs 3 intersect the first section 15a. Although second sections 15b, aligned in the Y direction, of an adjacent pair of the first sections 15a are shown separated in FIG. 1, they may also be interconnected if the external light absorbing layer 15 is made of a non-conductive material. Further, if the external light absorbing layer 15 is made of a non-conductive material, the second sections 15b may be made larger than when the layer is made of a conductive material.

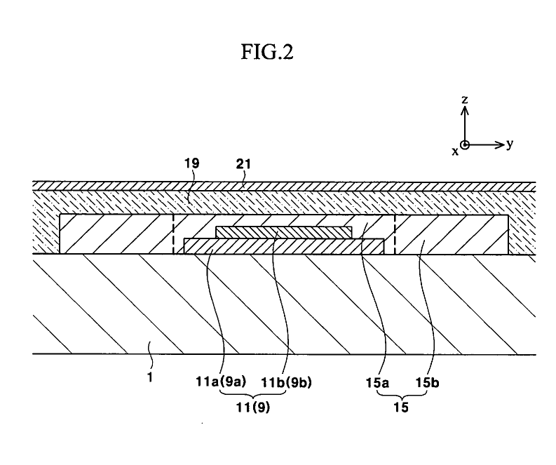

FIG. 2 is a sectional view taken along line A-A of FIG. 1. The external light absorbing layer 15 will be described in greater detail with reference to FIG. 2.

The external light absorbing layer 15 may be formed at locations corresponding to the transparent electrodes 9a, 11a and the bus electrodes 9b, 11b of the display electrodes 9, 11. When the display electrodes 9, 11 include only the bus electrodes 9b, 11b, the external light absorbing layer 15 may be formed corresponding to the bus electrodes. The light absorbing layer 15 may also be formed wider than the bus electrodes 9b, 11b so that it completely covers them. Consequently, since the bus electrodes 9b, 11b are typically made of a material such as Ag metal, the external light absorbing layer 15 may absorb external light while being formed in the non-discharge regions together with the barrier ribs 3, 5. Further, the bus electrodes 9b, 11b may be formed corresponding to the locations of the barrier ribs 5, thereby ensuring that the brightness of plasma discharge in the discharge cells 7R, 7G, 7B is not reduced.

The bus electrodes 9b, 11b may be made of a material such as Ag metal to compensate for the high resistance of the transparent electrodes 9a, 11a, and they may be formed on the front substrate 1 overlapping ends of the transparent electrodes. The external light absorbing layer 15 may be formed overlapping the bus electrodes 9b, 11b. More precisely, the first sections 15a may be formed overlapping the bus electrodes 9b, 11b, and the second sections 15b may be formed at locations between pairs of the adjacent transparent electrodes 9a or 11a.

The transparent electrodes 9a, 11a are coupled to the bus electrodes 9b, 11b, respectively, and they extend in a direction toward the center of the discharge cells 7R, 7G, 7B. The transparent electrodes 9a, 11a may also be formed in a stripe pattern extending along the same direction as, and overlapping, the corresponding bus electrodes 9b, 11b. The transparent electrodes 9a, 11a function to implement plasma discharge in the discharge cells 7R, 7G, 7B, and they may be made of indium tin oxide (ITO) to ensure brightness.

The external light absorbing layer 15 may have an opaque color, such as black, to better absorb light.

Other electrodes may be mounted on the front substrate 1 with the display electrodes 9, 11. FIG. 1 shows such a case where M electrodes 17 are mounted on the front substrate 1. The M electrodes 17 may comprise a transparent electrode 17a and a bus electrode 17b. Since the transparent electrode 17a and the bus electrode 17b of the M electrodes 17 have the same interrelation as the transparent and bus electrodes of the display electrodes 9, 11, a detailed description thereof will not be provided.

A second dielectric layer 19 may cover the display electrodes 9, 11 and the M electrodes 17. The second dielectric layer 19 may be made of a transparent dielectric material to ensure high light transmissivity levels. A protective layer 21, which may be made of MgO, may cover the second dielectric layer 19.

The display electrodes 9, 11 and the M electrodes 17 may be mounted in various ways.

To enable a sustain discharge in the discharge cells 7R, 7G, 7B following an address discharge, the display electrodes 9, 11 may be X, Y electrodes 9, 11 that are disposed opposing one another. The X, Y electrodes 9, 11 and the address electrodes are sufficient to implement the address, sustain, and reset discharges. However, when interposing the M electrodes 17 between pairs of the X, Y electrodes 9, 11, applying a scan voltage to an M is electrode 17 and an address voltage to a corresponding address electrode may implement an address discharge. In this case, the X, Y electrodes 9, 11 may be used to implement the sustain discharge. The different types of discharges may be obtained using other operations.

Further, the X, Y electrodes 9, 11 may have various mounting structures along the direction the address electrodes extend (i.e., along direction Y). An increasing variety of mounting structures may be employed by the X, Y electrodes 9, 11 when utilizing the M electrodes 17.

In the first exemplary embodiment of the present invention, the repeating electrode structure along direction Y includes an X electrode 9, an M electrode 17, a Y electrode 11, an M electrode, an X electrode, and so on. Therefore, an X electrode, an M electrode, and a Y electrode is provided for each discharge cell 7R, 7G, 7B. The X, Y electrodes 9, 11 extend into areas of an adjacent pair of the discharge cells 7R, 7G, 7B (i.e., adjacent along direction Y). Accordingly, from the perspective of the discharge cells aligned in a row along direction Y, the X, Y electrodes 9, 11 are provided in a repeating pattern of X-Y, Y-X, . . . , X-Y, Y-X, and one M electrode 17 is mounted between adjacent pairs of the X, Y electrodes 9, 11. This electrode structure may enable high resolution for the PDP, as well as high brightness resulting from the increased illumination area and aperture ratio.

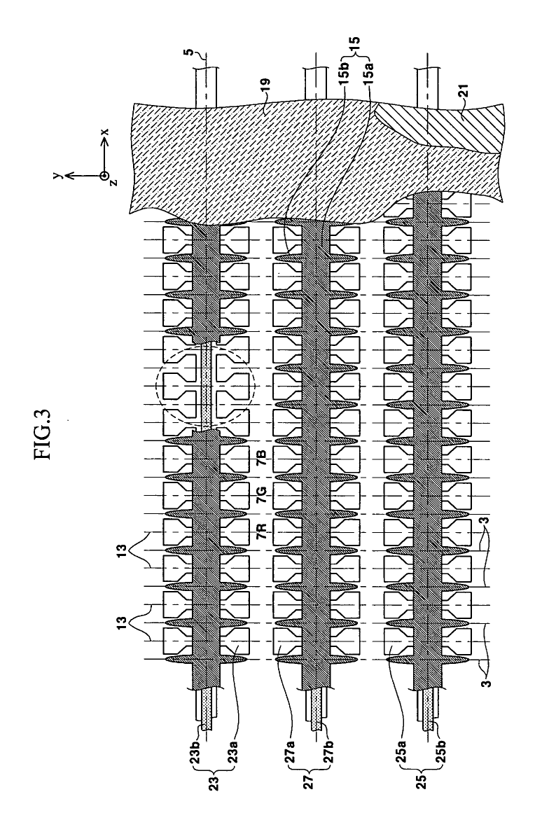

FIG. 3 is a schematic partial plan view of a PDP according to a second exemplary embodiment of the present invention.

Since the basic structure and operation of the second exemplary embodiment are similar to those of the first exemplary embodiment, only aspects of this embodiment that differ from the previous embodiment will be described.

The second exemplary embodiment does not include the M electrodes 17 of the first exemplary embodiment, and the display electrodes are mounted differently. Display electrodes 23, 25, 27 of the second exemplary embodiment are respectively formed as X1, X2, Y electrodes 23, 25, 27, and a repeating pattern of Y-X1-Y, Y-X2-Y, per discharge cell, is formed along direction Y. That is, one of the Y electrodes 27 may be interposed between an X1 and X2 electrode pair 23, 25.

Rows of the X1 electrodes 23 and the Y electrodes 27 may be even rows, and rows of the X2 electrodes 25 and the Y electrodes 27 may be odd rows, and these rows alternately repeat. Consequently, a high resolution of the PDP may be obtained, as well as high brightness resulting from the increased illumination area and aperture ratio.

The X1, X2, Y electrodes 23, 25, 27 may extend into the areas of adjacent pairs of the discharge cells 7R, 7G, 7B (i.e., adjacent along direction Y). The X1, X2, Y electrodes 23, 25, 27 may respectively include bus electrodes 23b, 25b, 27b, which extend along direction X, and transparent electrodes 23a, 25a, 27a, which extend from diametrically opposed sides of the bus electrodes 23b, 25b, 27b, respectively, toward centers of the discharge cells 7R, 7G, 7B. The transparent electrodes 23a, 25a, 27a are coupled to the bus electrodes 23b, 25b, 27b, respectively.

The external light absorbing layer 15 of the second exemplary embodiment, as in the first exemplary embodiment, includes the first section 15a, which extends along direction X and corresponds to a location of a barrier rib 5 to fully cover the same, and a plurality of the second sections 15b, which extend a predetermined distance from the first section 15a along direction Y and at locations corresponding to the barrier ribs 3 to partially cover the same. A pair of the second sections 15b may extend from diametrically opposed sides of the first section 15a at each location where the barrier ribs 3 intersect the first section 15a. Although second sections 15b, aligned in the Y direction, of an adjacent pair of the first sections 15a are separated as shown in FIG. 3, they may also be interconnected if the external light absorbing layer 15 is made of a non-conductive material.

FIG. 4 is a schematic partial plan view of a PDP according to a third exemplary embodiment of the present invention.

Since the basic structure and operation of the third exemplary embodiment are the same as those of the first exemplary embodiment, only aspects of this embodiment that differ from the first embodiment will be described in the following.

The third exemplary embodiment does not include the M electrodes 17 of the first exemplary embodiment, and it utilizes a delta-type barrier rib structure. In more detail, barrier ribs 29 define the discharge cells 7R, 7G, 7B independently and in substantially a hexagonal shape. Further, red, green, and blue subpixels of a delta configuration may form each pixel.

The display electrodes 9, 11 may be formed as X, Y electrodes. The X, Y electrodes 9, 11 may be formed in an alternating pattern, along direction Y, of X-Y, Y-X, etc. in discharge cells arranged in the delta configuration. The X, Y electrodes 9, 11 may extend into two adjacent discharge cells 7R, 7G, 7B. Further, the X, Y electrodes 9, 11 may respectively include bus electrodes 9b, 11b, which extend along direction X and are formed in a zigzag shape corresponding to the hexagonal formation of the barrier ribs 29, and transparent electrodes 9a, 11a, which extend from opposite sides of the bus electrodes 9b, 11b, respectively, toward centers of the discharge cells 7R, 7G, 7B. The transparent electrodes 9a, 11a are coupled to the bus electrodes 9b, 11b, respectively.

The external light absorbing layer 15 of the third exemplary embodiment, as in the first exemplary embodiment, may include the first section 15a, which extends along direction X in a zigzag configuration to correspond to the shape of the barrier ribs 29 and the bus electrodes 9b, 11b, and a plurality of the second sections 15b, which extend a predetermined distance from the first section 15a along direction Y and at angled portions of the first section 15a and on both sides of the first section 15a. Although second sections 15b, aligned in the Y direction, of an adjacent pair of the first sections 15a are separated as shown in FIG. 4, they may also be interconnected if the external light absorbing layer 15 is made of a non-conductive material.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a first substrate and a second substrate provided opposing one another with a gap therebetween;
barrier ribs formed in the gap to define discharge cells;
an address electrode formed along a first direction and intersecting areas corresponding to the discharge cells;
a display electrode formed on the first substrate along a second direction substantially perpendicular to the first direction; and
a light absorbing layer covering a portion of the display electrode.

2. The PDP of claim 1, wherein the light absorbing layer is formed in a non-discharge region.

3. The PDP of claim 1,
wherein the barrier ribs comprise a first barrier rib extending along the second direction and a second barrier rib extending along the first direction; and
wherein the light absorbing layer comprises:
a first section extending along the second direction and corresponding to a location of the first barrier rib to cover the first barrier rib; and
a plurality of second sections protruding in the first direction from the first section and at locations corresponding to second barrier ribs to partially cover the second barrier ribs.

4. The PDP of claim 1, wherein the display electrode comprises:
a bus electrode extending along the second direction; and
a transparent electrode protruding in the first direction from the bus electrode,
wherein the light absorbing layer covers the bus electrode.

5. The PDP of claim 4, wherein the light absorbing layer is wider than the bus electrode.

6. The PDP of claim 4, wherein the transparent electrode protrudes toward a center of a discharge cell.

7. The PDP of claim 1, wherein the light absorbing layer is made of a black material.

8. The PDP of claim 1, wherein the barrier ribs are closed-type barrier ribs.

9. The PDP of claim 8, further comprising:
an M electrode between adjacent display electrodes,
wherein the display electrode comprises X electrodes and Y electrodes.

10. The PDP of claim 9, wherein the X electrodes and the Y electrodes extend into two adjacent discharge cells in the first direction.

11. The PDP of claim 9, wherein the X electrodes and the Y electrodes comprise:
a bus electrode extending along the second direction, and
a plurality of transparent electrodes coupled to the bus electrode and extending in the first direction toward centers of corresponding discharge cells.

12. The PDP of claim 8,
wherein the display electrode comprises X1 electrodes, X2 electrodes, and Y electrodes, and
wherein the X1 electrodes, the X2 electrodes, and the Y electrodes are provided in a repeating pattern along the first direction of Y-X1-Y-X2-Y.

13. The PDP of claim 12, wherein the X1 electrodes, the X2 electrodes, and the Y electrodes extend into two adjacent discharge cells in the first direction.

14. The PDP of claim 12, wherein the X1 electrodes, the X2 electrodes, and the Y electrodes comprise:
a bus electrode extending along the second direction, and
a plurality of transparent electrodes coupled to the bus electrode and extending in the first direction toward centers of corresponding discharge cells.

15. The PDP of claim 1,
wherein the barrier ribs define the discharge cells independently and in substantially a polygonal shape; and
wherein the discharge cells are arranged in a delta configuration.

16. The PDP of claim 15, wherein the polygonal shape is a hexagon.

17. The PDP of claim 15,
wherein the display electrode comprises X electrodes and Y electrodes, and
wherein the X electrodes and the Y electrodes are provided in a repeating and alternating pattern along the first direction of X-Y, Y-X in discharge cells arranged in the delta configuration.

18. The PDP of claim 17, wherein the X electrodes and the Y electrodes extend into two adjacent discharge cells in the first direction.

19. The PDP of claim 15, the X electrodes and the Y electrodes comprise:
a bus electrode extending along the second direction in a zigzag configuration, and
a plurality of transparent electrodes coupled to the bus electrode and extending in the first direction toward centers of corresponding discharge cells.
